(19) United States
(12) Patent Application Publication
(10) Pub. No.: US 2005/0057358 A1
(43) Pub. Date: Mar. 17, 2005

(54) Remote doorbell push button transmitter

(76) Inventor: Ching Cheng Chen, Taipei (TW)

Correspondence Address: JAMES D. HALL;BOTKIN & HALL, LLP, 105 E. JEFFERSON BLVD., SUITE 400, SOUTH BEND, IN, 46601, US

(21) Appl. No.: 10/664,424

(22) Filed: Sep. 17, 2003

(51) Int. Cl. G08B 1/08

(52) U.S. Cl. 340/539.14

(57) ABSTRACT

A push button doorbell activator which is for transmitting a radio frequency signal to activate a doorbell chime and which has a metallic outer housing separated into two parts enclosing a transmitter circuit and an antenna and a non-metallic push button integrally interposed between the two housing parts.

### BACKGROUND OF THE INVENTION

1. Field of the Invention

The invention disclosed herein relates to doorbells, and more specifically, to a push button switch with a radio frequency transmitter for activating a remote doorbell.

2. Discussion of the Prior Art

In the field of doorbells, it is often desirable to have a doorbell with a chime that is remote from the push button activation switch located at the exterior of the door. It is also often desirable to have a push button switch with a metal cover, such as brass, in order to appear to be of superior quality. It is known to have a doorbell with a push button switch that activates a radio frequency transmitter and a remote chime with a radio frequency receiver so that the chime is activated when the push button switch is pushed.

One such prior art doorbell assembly includes a push button switch with an RF transmitter and antenna enclosed within a metal housing, as depicted in FIGS. 1A and 1B. In the doorbell transmitters of FIGS. 1A and 1B, the metal housing is divided into two unequal parts 12a, 12b spaced to create a gap 14, which is filled with a non-metallic substance such as silicon rubber. In the doorbell transmitter of FIG. 1A, push button 16 for activating the transmitter is metal. In the doorbell transmitter of FIG. 1B, a gap 18 is located around the push button 16 filled with a non-metallic substance. A problem with this arrangement, however, is that the transmission of the RF signal is significantly impeded by the metal enclosure. Therefore, it would be desirable to have a doorbell button with an RF transmitter and antenna enclosed in an attractive metal housing that has increased transmission range.

### SUMMARY OF THE INVENTION

The invention disclosed herein includes a push button doorbell activator for remotely activating a doorbell chime by transmitting a radio frequency signal to a receiver connected to the doorbell chime. The doorbell activator includes a radio frequency transmitter circuit having an antenna for transmitting the signal. The transmitter circuit is carried within a non-metallic casing. A non-metallic push button for activating the transmitter circuit is interposed between opposing spaced apart half parts of a metallic housing, which partially encases the transmitter circuit casing. The antenna is positioned near the gap between the half parts of the metallic housing.

An object of the invention is to provide a push button doorbell activator for remotely activating a doorbell chime with a radio frequency signal in which the doorbell activator is encased within a metal housing. Another object of the invention is to provide a metallic doorbell push button RF transmitter having an improved transmission range.

### BRIEF DESCRIPTION OF THE DRAWINGS

These and other aspects of the invention will become more apparent from the following discussion with reference to the drawings, in which:

FIG. 1A depicts a prior art push button doorbell transmitter;

FIG. 1B depicts a second prior art push button doorbell transmitter;

FIG. 2 shows the preferred embodiment of the metal doorbell push button transmitter or activator having a two-piece metal housing in isolation;

FIG. 3 shows an exploded view of the various subcomponents of the doorbell activator of FIG. 2;

FIG. 4 is a rear view of a partial assembly of the doorbell activator of FIG. 2;

FIG. 5 is a longitudinal cross sectional view of the doorbell activator of FIG. 2;

FIG. 6 is a schematic diagram of the transmitter circuit used in the doorbell activator;

FIG. 7 shows an alternative push button doorbell transmitter having a one-piece housing.

FIG. 8 schematically depicts the set up for testing the doorbell activator and prior art activators;

FIG. 9 is a chart comparing the test results of the two-piece housing doorbell activator of FIG. 2 with the one-piece housing doorbell activator of FIG. 7; and,

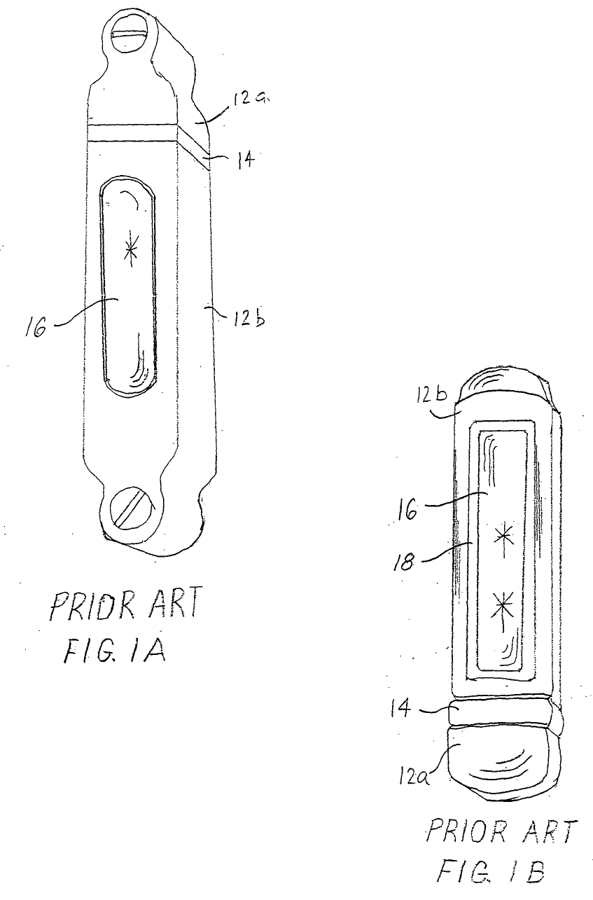

### DETAILED DESCRIPTION

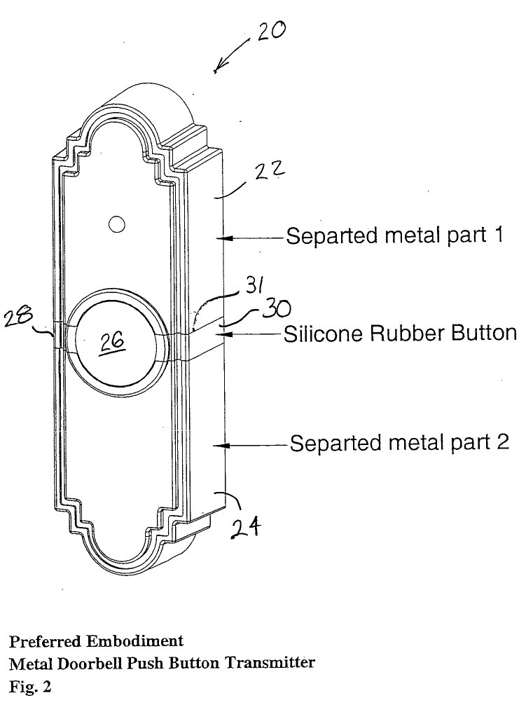

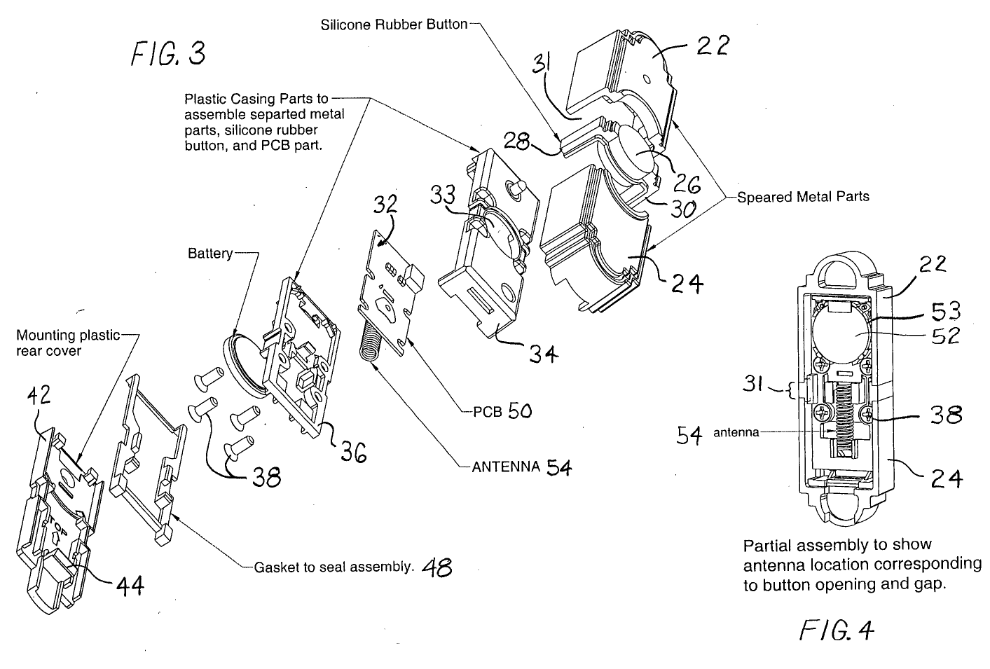

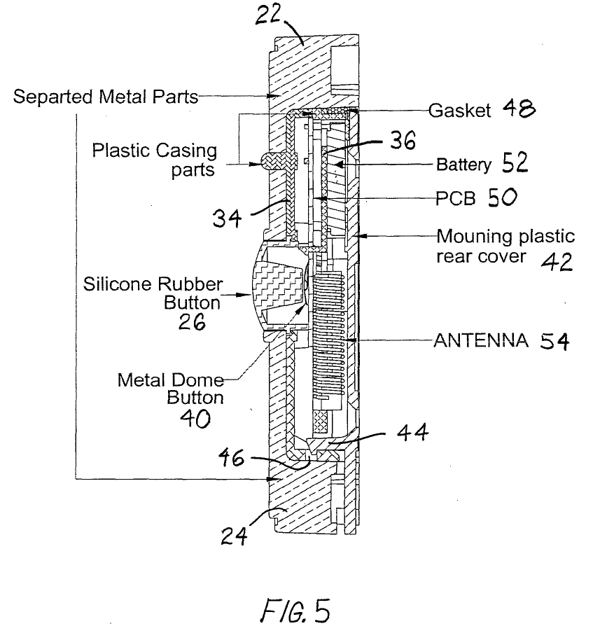

Turning now to the drawings, in the preferred embodiment of the invention, as depicted in FIGS. 2-6, a metallic push button doorbell transmitter or activator 20 includes an exterior housing made of metal, preferably brass, which is divided into two spaced apart symmetrical half parts 22, 24. A silicone rubber push button 26 includes a pair of integral side extension parts 28, 30 which protrude from opposite sides of the bush button. Push button 26 and side extensions 28, 30 are sandwiched in the gap 31 between housing half parts 22, 24 with the extensions following the contours of the housing half parts. The silicon rubber material for push button 26 and extensions 28, 30 preferably has a luminous or fluorescent property such that the material absorbs light energy when exposed to light and then emits light in the dark.

A transmitter circuit 32 is encased between an opposing pair of plastic casing parts 34, 36. Transmitter circuit 32 is secured between casing parts 34, 36 within housing half parts 22, 24 with fasteners 38. A hole 33 in casing part 34 allows the back end of push button 26 to contact a switch 40, which is preferably a metal dome button, for activating transmitter circuit 32. When assembled, casing parts 34, 36, housing parts 22, 24, and push button 26 form a sealed environment for transmitter circuit 32.

A mounting plate 42 for mounting the doorbell transmitter 20 to a mounting surface includes a resilient barbed tab 44. Mounting plate 42 may be secured to a mounting surface such as a wall or door frame. Doorbell transmitter 20 is then snap-fitted onto mounting plate 42 with barbed tab 44 snapping into a complementary groove 46 in casing part 36. A gasket seal 48 around the periphery of the junction between mounting plate 42 and casing part 36 prevents water from seeping downwardly into the space behind casing part 36.

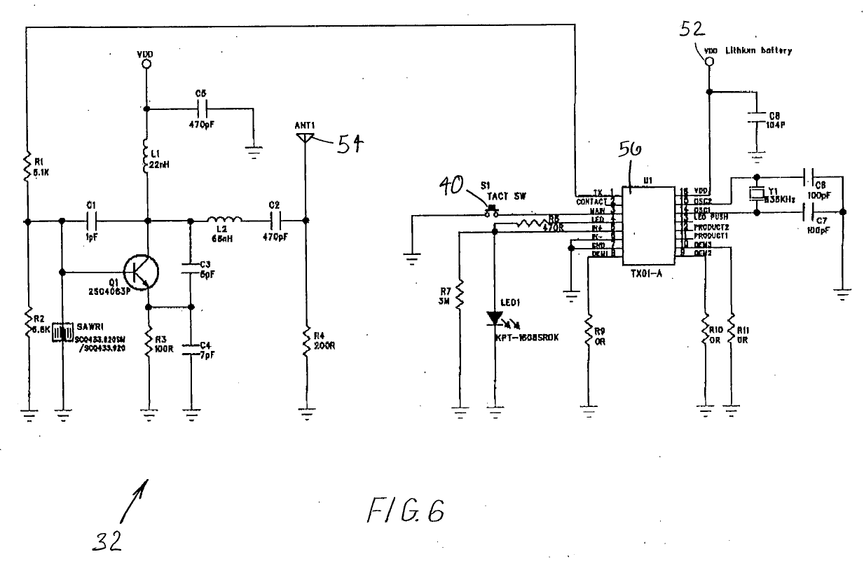

Transmitter circuit 32 is a SAW resonator based transmitter circuit tuned to fifty ohm impedance matching. Transmitter circuit includes a printed circuit board (PCB) 50, a power source such as a battery 52 located within battery compartment 53, an antenna 54, and switch 40. PCB 50 includes integrated circuit (IC) 56 and associated electronic components as shown in FIG. 6 such that when push button 26 closes switch 40, a radio frequency signal is emitted from antenna 54. This radio frequency signal is transmitted to a receiver (not shown) used to activate a remote doorbell chime in a fashion known in the art. Antenna 54, shown here as a helically wound coil, is positioned on PCB 50 within casing parts 34, 36 adjacent the gap 31 between housing parts 22 and 24 aligned directly underneath push button 26 and button extensions 28, 30 to enhance the transmission range of the RF signal. The circuitry on PCB 50 is ground plain incorporated referring to one of the metal housings 22, 24 to form a steady environment.

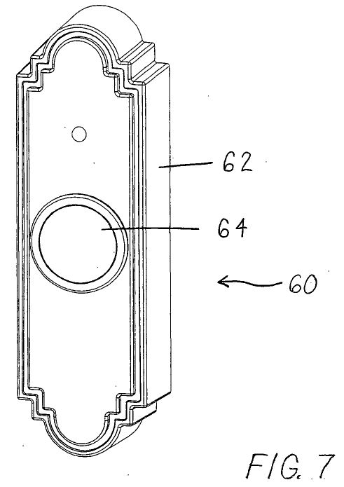

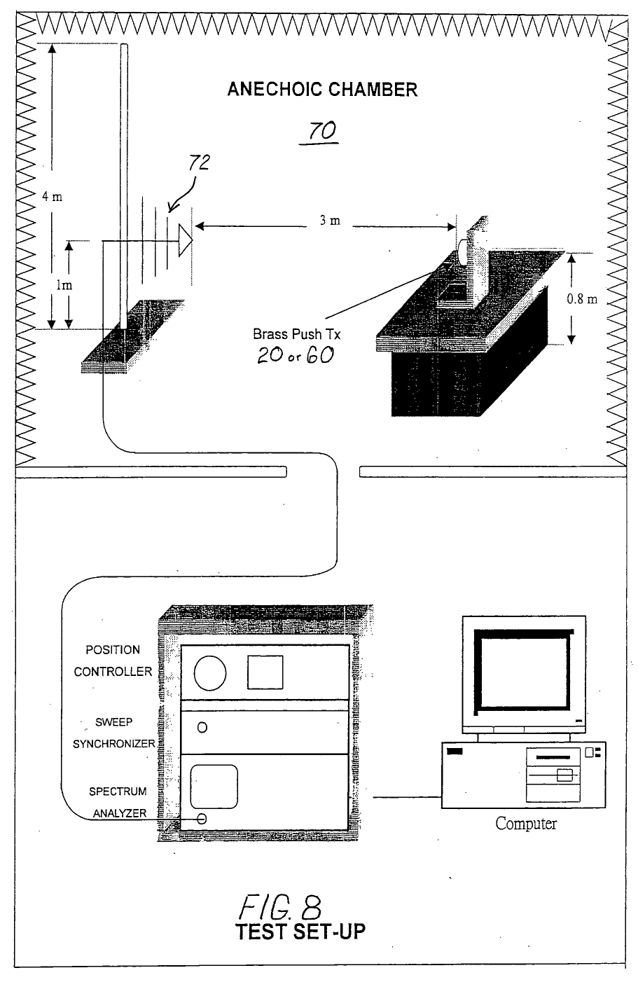

In FIG. 7, an alternative embodiment of a metal doorbell button transmitter 60 is shown. This transmitter 60 has a single piece metal housing 62 with an opening in its front side where a non-metallic button 64—preferably made of silicon rubber—for activating the RF transmitter switch is located. The transmitter circuitry is the same as already described herein such that, when button 64 is pushed, an RF signal is transmitted to a receiver to activate a remote chime. The transmitter has an antenna (not shown), which is within housing 62 and aligned behind push button 64 to maximize the effective transmission range of the RF signal.

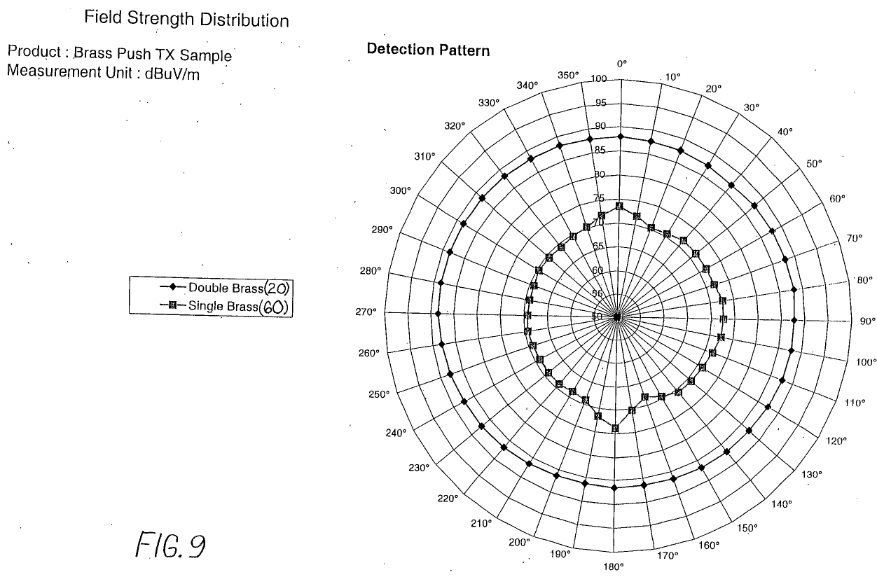

Turning now to FIGS. 8 and 9, tests were performed on the two-part brass housing doorbell actuator 20 of FIGS. 2-6 and the one-part brass housing doorbell actuator 60 of FIG. 7. Each test specimen 20 and 60 was set up individually within an anechoic chamber 70 with the test specimen located a fixed distance from a receiving antenna 72. The signal transmission of each doorbell transmitter specimen 20 or 70 was then recorded and analyzed. From the resulting analysis of the test data thus obtained, as shown in FIG. 9, the two-piece housing doorbell transmitter 20 was able to transmit a usable signal more effectively than the one-piece housing doorbell transmitter 60.

The description of the preferred embodiment related herein is not meant to act as a limitation on any obvious and minor variations on the invention as claimed.

1. A pushbutton doorbell activator for remotely activating a doorbell chime by transmitting a radio frequency signal to a receiver associated with the doorbell chime, said doorbell activator comprising a radio frequency transmitter circuit including an antenna for transmitting said signal, a non-metallic pushbutton for activating said transmitter circuit, a non-metallic casing carrying said transmitter circuit and said antenna, a metallic housing partially encasing said casing, said housing including first and second opposing half parts, said half parts spaced from each other to form a gap, said pushbutton interposed between said first and second housing half parts in said gap, said antenna aligned with said gap.

2. The doorbell activator of claim 1 wherein said pushbutton includes a pair of oppositely located extension parts, said extension parts located between said housing parts in said gap.

3. The doorbell activator of claim 2 wherein said pushbutton is made of silicone rubber and said non-metallic casing is made of plastic.

4. The doorbell activator of claim 3 and further comprising a rear mounting plate, said mounting plate securable to a mounting surface, said mounting plate connected to said casing.

5. The doorbell activator of claim 4 and further comprising a gasket seal between said mounting plate and said casing.
